(19) United States
(12) Patent Application Publication
(10) Pub. No.: US 2017/0253428 A1
(43) Pub. Date: Sep. 7, 2017

(54) RECEPTACLE

(71) Applicant: GWT Corporation, Alpharetta, GA (US)

(72) Inventors: Gregg Tobin, Alpharetta, GA (US); Kimberly Pennington Tobin, Alpharetta, GA (US)

(21) Appl. No.: 15/255,093

(22) Filed: Sep. 1, 2016

Related U.S. Application Data
(60) Provisional application No. 62/303,039, filed on Mar. 3, 2016.

(51) Int. Cl. B65F 1/00; B65D 33/28

(52) U.S. Cl. CPC B65F 1/002; B65D 33/28; B65F 2250/114; B65F 2250/105; B65F 2250/108

(57) ABSTRACT

A receptacle has a substantially flat sheet having a perimeter edge, a plurality of loops positioned adjacent the perimeter edge of the substantially flat sheet, and at least two strings coupled thereto. Each of the at least two strings has a first end and a second end so that when the first string is threaded through the plurality of loops, the first string first end is coupled to the first string second end or to the substantially flat sheet adjacent one another. Furthermore, when the second string is threaded through the plurality of loops the second string first end is coupled to the second string second end or to the substantially flat sheet adjacent one another. In various embodiments, the first string can be pulled relative to the second string to cause the perimeter edge to cinch forming a receptacle with an opening defined by the perimeter edge.

### CROSS REFERENCE TO RELATED APPLICATIONS

This application claims the benefit of U.S. Provisional Patent Application No. 62/303,039, filed Mar. 3, 2016, entitled “RECEPTACLE,” which is incorporated herein by reference in its entirety.

### BACKGROUND

Prior art garbage receptacles utilize a generally cylindrical shaped body that is sealed at one end and contains a drawstring at the opposite end for closing the bag when it is loaded with garbage. These types of receptacles are problematic since they do not stand upright and open when empty. Moreover, when loading these types of receptacles, the user must bend over and lift the trash into the opening of the garbage bag. This configuration causes some garbage to fall out of the bag, possibly tip the bag over or even tear the bag since the user is trying to navigate the garbage through the opening. Various embodiments of the present receptacle designs and methods thereof recognize and address the foregoing considerations, and others, of prior art designs and methods of use.

### SUMMARY OF THE INVENTION

In various embodiments, a receptacle comprises a substantially flat sheet having a perimeter edge. A plurality of loops are positioned adjacent the perimeter edge of the substantially flat sheet. At least two strings each comprise a first end and a second end so that when the first string is threaded through the plurality of loops the first string first end is coupled to the first string second end or to the substantially flat sheet adjacent one another. Furthermore, when the second string is threaded through the plurality of loops the second string first end is coupled to the second string second end or to the substantially flat sheet adjacent one another. In various embodiments, the first string can be pulled relative to the second string.

In some embodiments, the substantially flat sheet is substantially circular in shape and formed from a pliable material such as a plastic, a polymer, a biodegradable material or paper. In other embodiments, the receptacle further comprises a third string that is coupled to the flat sheet intermediate a center point of the substantially flat sheet and the first and second strings. The third string is moveable with respect to the substantially flat sheet so that when pulled, the third string pulls a portion of the substantially flat sheet at a radius from the center point toward itself forming an elongated generally cylindrical body where the center point of the substantially flat sheet is positioned at a bottom of the generally cylindrical body. In various embodiments, the third string may be woven into the substantially flat sheet where at least a portion of the third string is accessible by the user to allow the user to pull the third string relative to the substantially flat sheet.

In various embodiments, a first elongated loop is positioned adjacent the perimeter edge of the substantially flat sheet wherein the first elongated loop is positioned adjacent the perimeter of the substantially flat sheet. The first elongated loop comprises a first end and a second end. A second elongated loop is also positioned adjacent the perimeter of the substantially flat sheet, where the second elongated loop also comprises a first end and a second end. A first gap is positioned intermediate the first elongated loop first end and the second elongated loop second end, and a second gap is positioned intermediate the first elongated loop second end and the second elongated loop first end. In various embodiments, a first portion of the first string and a first portion of the second string are accessible at the first gap, and a second portion of the first string and a second portion of the second string are accessible at the second gap. In some embodiments, the first string is of a first color and the second string is of a second color. In various embodiments, when the first string is pulled relative to the second string, the substantially flat sheet transforms into a sack with an opening defined by the perimeter of the substantially flat sheet.

In some embodiments, a plurality of ribs extends linearly across the substantially flat sheet from a first point on the perimeter to a second point on the perimeter. In particular embodiments, each of the plurality of ribs pass through a center point of the substantially flat sheet. In some of these embodiments, each of the plurality of ribs are formed integral with the substantially flat sheet.

In particular embodiments, one or more stakes are used to releasably secure the perimeter of the substantially flat sheet to a ground surface. Each one of the one or more stakes comprises a first portion that is inserted into the ground and a second portion that is configured to press against a portion of the perimeter of the substantially flat sheet to maintain the substantially flat sheet in an open position. In some embodiments, the one or more stakes can be used to secure one of the plurality of fasteners to the ground so that another one of the one or more fasteners can be pulled with respect to the one of the one or more fasteners secured to the ground. In this way, a single user can easily use the receptacle.

In various embodiments, the plurality of loops are selected from a group consisting of (1) a plurality of cutouts formed about the perimeter of the substantially flat sheet, (2) a plurality of loops formed by hemming the edge of the substantially flat sheet adjacent the perimeter, (3) a plurality of loops formed by coupling the loops to the substantially flat sheet adjacent the perimeter; or (4) a plurality of loops formed from the same material as the substantially flat sheet.

In another embodiments of a receptacle, the receptacle comprises a substantially flat sheet having a perimeter, a plurality of loops positioned adjacent the perimeter of the substantially flat sheet, and at least two strings comprising, wherein the first string and the second string are retained in place by the plurality of loops, the sheet is moveable between a first position in which sheet is substantially flat, and a second position in which the sheet forms a container having an open mouth when the first string is pulled with respect to the second string in an radially outward direction.

The following method can be used to manufacture any one of the above discussed receptacles. First, a substantially flat sheet comprising a perimeter is formed. Next, a plurality of fasteners are attached adjacent the perimeter of the substantially flat sheet. In various embodiments, a first fastener is moveable with respect to a second fastener and when the first fastener is moved with respect to the second fastener, the substantially flat sheet is transformed into a container having an opening defined by the perimeter.

### BRIEF DESCRIPTION OF THE DRAWINGS

Various embodiments of an apparatus, system, and method for a receptacle are described below. In the course of this description, reference will be made to the accompanying drawings, which are not necessarily drawn to scale, and wherein:

FIG. 1 shows a top perspective view of a receptacle;

FIG. 2 shows a side perspective view of the receptacle of FIG. 1, in a first position;

FIG. 3 shows a side perspective view of the receptacle of FIG. 1 in a second position;

FIG. 4 shows a side perspective view of the receptacle of FIG. 3 with the top cinched closed;

FIG. 5 shows a top view of an alternate embodiment of a receptacle;

FIGS. 6A-6B show a top view and a side perspective view of the receptacle of FIG. 1 using stakes to maintain the receptacle in position;

FIG. 7 shows a top view of the receptacle of FIG. 5 after the strings are pulled; and

FIG. 8 shows a belt structure that may be used in any one of the embodiments of the receptacle.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

This disposal system provides a user with a means of quickly and effectively collecting and encapsulating waste, debris and/or various objects within itself by pulling the uniquely designed two or more drawstrings so that the perimeter of the disposal system collapses and encloses around the waste, debris and/or various objects within.

### Preferred Embodiments

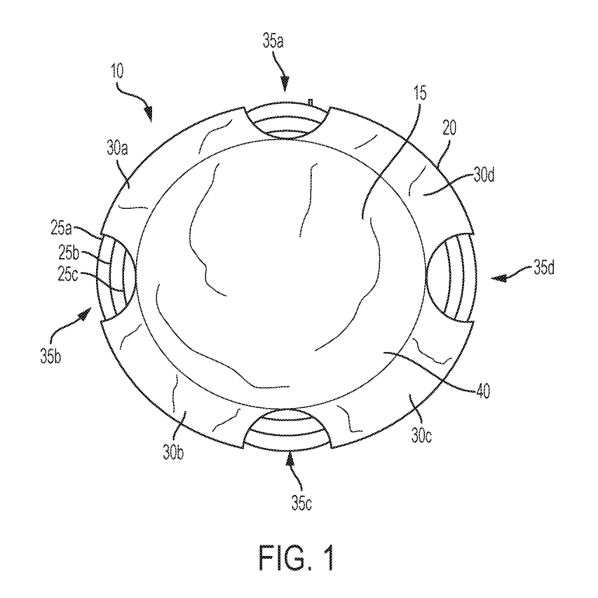

Referring to FIG. 1, the receptacle 10 is substantially circular in shape and substantially flat. The receptacle is formed from a single piece of material 15 selected from a plastic, a polymer, a biodegradable material, a cloth, a weave, paper, etc. The receptacle 10 is typically laid flat on a surface so that the user can add any waste, debris and/or various objects to the inside of the perimeter 20 of the receptacle. The receptacle further comprises a plurality of fasteners 25a, 25b, 25c (e.g., strings, ropes, cords, etc.) that are maintained proximate (e.g., adjacent, substantially adjacent, partially offset from, etc.) the perimeter 20 of the receptacle 10 by a plurality of loops 30a, 30b, 30c, 30d (e.g., two or more loops). Intermediate two adjacent loops is a gap 35a, 35b, 35c, 35d where the fasteners 25a, 25b, 25c are accessible.

In various embodiments, the plurality of loops 30a, 30b, 30c, 30d may be formed by folding over a portion of an edge of the substantially flat piece of material 15 and forming a seam 40. In some embodiments, the seam may be sewn. In other embodiments where the material is a polymer, the seam may be formed by heating and melting the folded over material to itself. In still other embodiments, the plurality of loops may be formed from a separate material that is then coupled to the substantially flat material 15 by any suitable fastener (e.g., glue, sewn, heat welded, friction stir welding, etc.).

In various embodiments, the fasteners 25a, 25b, 25c may each be of a different color to allow the user to distinguish one fastener (e.g., 25a) from another of the fasteners (e.g., 25b). It should be understood that in addition to, or instead of being a different color, the fasteners could be formed of a different texture and/or size to help distinguish one fastener from another fastener. For example, in other embodiments, the diameter of each fastener may be different or have another differentiating characteristic thereby allowing the user to distinguish one fastener from the other. In various embodiments, the fastener is a circular cord. In other embodiments, the fastener may be of any shape depending on the shape of the substantially flat material 15. In various embodiments, the fasteners 25a, 25b, 25c may be formed from a plastic, a polymer, a biodegradable material, paper or any other suitable material.

### Use of Preferred Embodiments

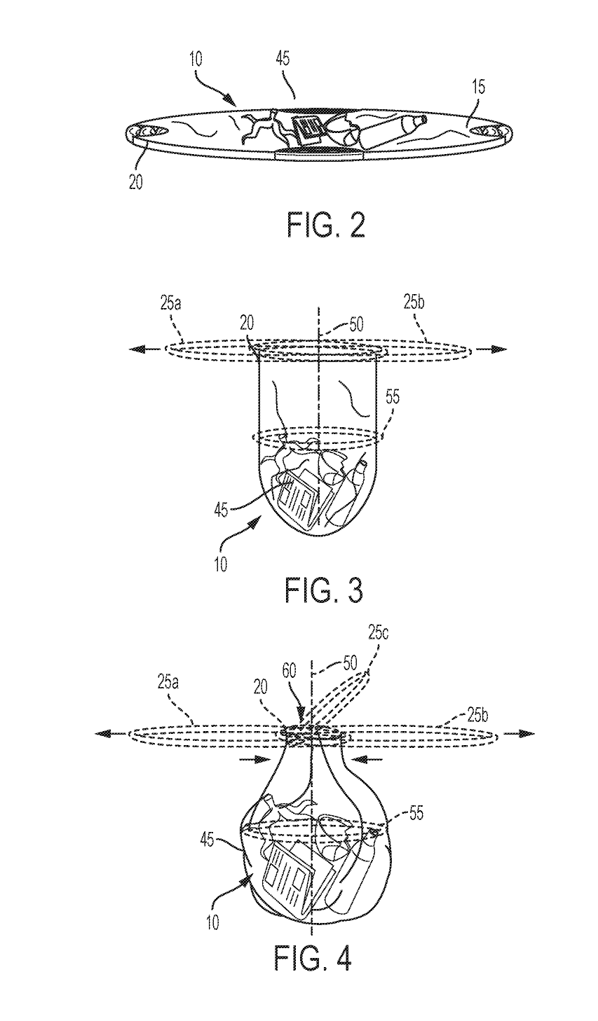

Referring to FIG. 2-4, after the user deposits the waste, debris and/or various objects 45 onto the substantially flat receptacle material 10, the user then pulls one of plurality of fasteners 25a (e.g., two or more the drawstrings) in a direction away from the center 50 of the receptacle 10 until the perimeter edges 20 of the receptacle 10 collapse toward each other and the center 50 of the receptacle 10 in such a way that the receptacle 10 forms a container with an opening defined by the perimeter edge 20 of the substantially flat material 15 thereby encapsulating the waste, debris and/or various objects 45 within. Referring specifically to FIG. 3, another fastener 55 may be positioned halfway between the perimeter 20 and the center 50 of the substantially flat material 15 to allow the user to cinch the fastener 55 to provide support and stability along the length of the receptacle 10 as the receptacle is filled. Referring specifically to FIG. 4, in various embodiments, a third fastener 25c may be used to help cinch the opening of the receptacle. In these embodiments, the user may pull on one end of the third fastener 25c as shown to further close the opening 60 defined by the cinched perimeter 20 if the substantially flat material 15.

The design and function of the fasteners 25a, 25b, 25c of the receptacle are unique from other receptacles in that as the two or more drawstrings are pulled in a direction away from the center of the perimeter of the receptacle, the perimeter 20 edges of the receptacle move in the opposite direction of the pulling motion of the fasteners or toward the center 20 of the receptacle 10 eventually forming a closed receptacle (as shown in FIG. 4). The greater the distance that the two or more fasteners are pulled with respect to one another, the greater the distance that the perimeter 20 edges move in the opposite direction toward the center [130] of the receptacle 10.

### Alternate Embodiment

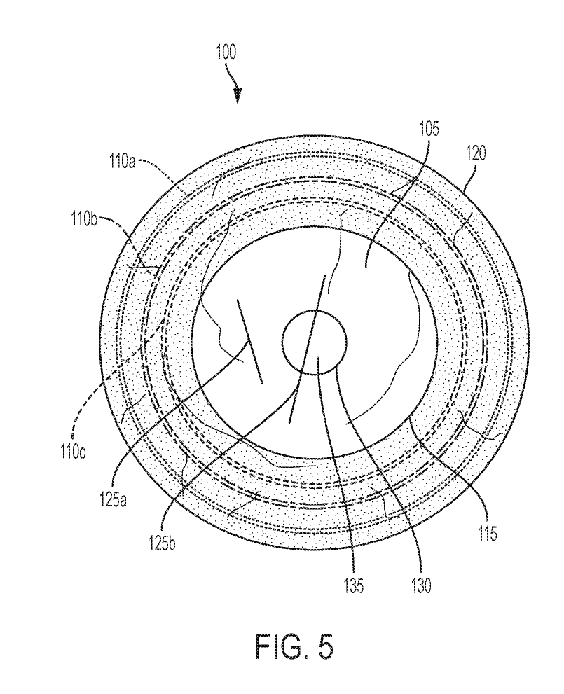

Referring to FIG. 5, an alternate embodiment of a receptacle 100 is shown. The receptacle 100 is substantially circular in shape and substantially flat. The receptacle is formed from a single piece of material 105 selected from a plastic, a polymer, a biodegradable material, a weave or paper. The receptacle 100 is typically laid flat on a surface so that the user can add any waste, debris and/or various objects to the inside of the perimeter 120 of the receptacle. The receptacle further comprises a plurality of fasteners 110a, 110b, 110c (e.g., strings, ropes, cords, etc.) that are maintained proximate (e.g., adjacent, substantially adjacent, partially offset from, etc.) the perimeter 120 of the receptacle 100 intermediate the perimeter edge 120 and area 115 inward from the perimeter edge. The fasteners 110a, 110b, 110c may be attached to the substantially flat material 105 by weaving the fasteners through the material 105 in the area of the material intermediate the perimeter 120 and the area 115 so that the fasteners are moveable with respect to the substantially flat material 105. The fasteners 110a, 110b, 110c may also be coupled to the substantially flat material by a plurality of loops that are coupled to the substantially flat material by heat welding, friction stir welding, by adhesive or via any other means that couples the loops to the material. In various embodiments, the substantially flat material may contain a series of holes in a circular pattern where each hole is spaced apart from the next adjacent hole. Thus, during manufacture of the receptacle 100, the fasteners 110a, 110b, 110c may be weaved through the holes. In some embodiments, each fastener may be weaved through a separate hole in the material such that when there are two fasteners each is weaved through every other hole. In embodiments where there are three fasteners each fastener may be weaved through every third hole. In still other embodiments, three series of holes may be formed in a circular pattern each along a different radius from the center 135. Such an arrangement allows the user to distinguish one fastener from the next.

In various embodiments, the fasteners 110a, 110b, 110c may each be of a different color to allow the user to distinguish one faster (e.g., 110a) from another of the fasteners (e.g., 110b). In other embodiments, the diameter of each fastener may be different thereby allowing the user to distinguish one fastener from the other. In various embodiments, the fastener may be a circular cord. In other embodiments, the fastener may be of any shape depending on the shape of the substantially flat material 105. In various embodiments, the fasteners 110a, 110b, 110c may be formed from a plastic, a polymer, a biodegradable material, paper or any other suitable material.

In various embodiments, one or more ribs 125a and 125b may be attached to the substantially flat material 105. In some embodiments, the one or more ribs 125a and 125b may be coupled to a bottom surface (the surface that faces out of the receptacle 100 when the fasteners are cinched) of the substantially flat material 105. In other embodiments, the one or more ribs 125a and 125b may be coupled to the top surface (the surface that faces in the receptacle 100 when the fasteners are cinched) of the substantially flat material 105. In still other embodiments, the one or more ribs may be integrally formed with the material used to form the substantially flat material 105. That is, in these embodiments, the rib may be formed by extra material thereby providing an area of material that provides extra strength along a particular length of the substantially flat material 105.

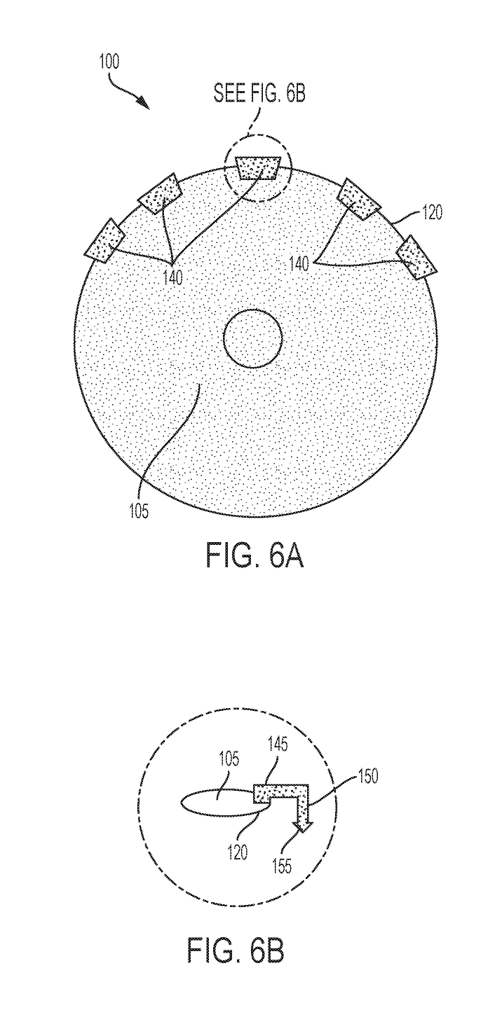

Referring to FIG. 6, the receptacle 100 of FIG. 5 is shown using one or more stakes 140 to secure the perimeter 120 of the substantially flat material 105 to the ground. That is, the stakes 140 prevent the edges of the substantially flat material 105 from rolling or bunching up as the user loads waste or debris onto the substantially flat material 105. Each stake 150 may comprise a horizontal first portion 145 that extends over the edge of the perimeter 120 and a second perpendicular portion 150 that is configured to be inserted into the ground. A spike or tip 155 may be formed on an end of the second perpendicular portion to assist in pressing the stake into the ground. In some embodiments, the spike may be barbed to help retain the spike in the ground.

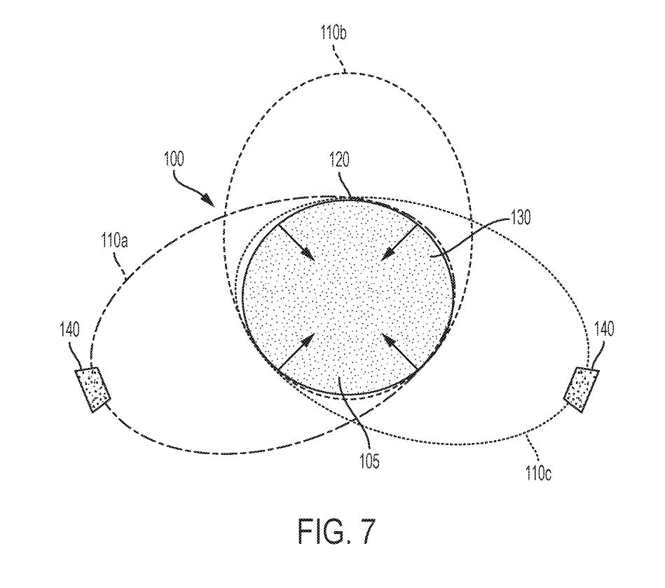

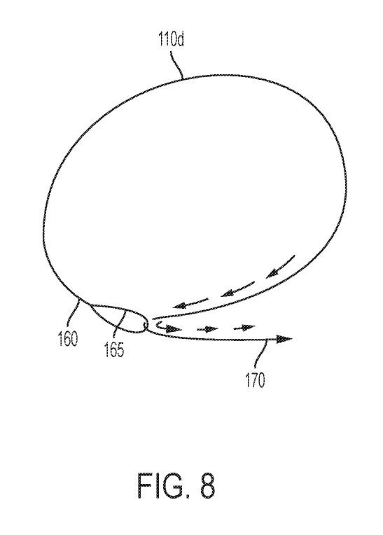

Referring to FIG. 7, once the substantially flat material has been loaded by the user, the user may reuse the one or more spikes 140 in order to secure one or more of the fasteners 110a and 110c in place. That is, one or more of the stakes 140 may be used to secure a first fastener 110a and a second fastener 110c to the ground so that the user can pull on the third fastener 110b. This is especially useful when the user is working alone with the receptacle 110. By securing the first 110a and second 110c fasteners to the ground, when the user pulls on the third fastener 110b, the first 110a and second 110c fasteners are pulled away from a center 130 of the receptacle 100 as the second fastener 110b is pulled in a direction away from the center 130 of the receptacle 110 thereby causing the perimeter 120 edges of the receptacle 100 to collapse toward each other in such a way that the receptacle 100 encapsulates the waste, debris and/or various objects within. The design and function of the fasteners 110a, 110b, 110c of the receptacle are unique from other receptacles in that as the two or more drawstrings are pulled in a direction away from the center of the perimeter of the receptacle, the perimeter 120 edges of the receptacle move in the opposite direction of the pulling motion of the fasteners or toward the center 120 of the receptacle 100 eventually forming a closed receptacle (as shown in FIG. 3). The greater the distance that the two or more fasteners are pulled with respect to one another, the greater the distance that the perimeter 120 edges move in the opposite direction toward the center 130 of the receptacle 100. Similar to the receptacle 10 shown in FIGS. 1-4, the receptacle 100 may also include an additional fastener 110d (FIG. 8) that can be used to further compress the circumference of the receptacle.

Referring to FIG. 8, the fastener 110d is shown where at least one end 160 of this particular fastener can be fixed to the receptacle material 105 using various manufacturing techniques and comprises a loop 165. The opposite end 170 of the fastener 110d can be inserted through the loop 165, which when pulled compresses the circumference of the receptacle in the area of the material intermediate the one or more fasteners 110a, 110b, 110c and the center 130 thereby providing structural support to the central area of the receptacle 100. It should also be understood that fastener 110d could also be used in place of fasteners 110a-110c or in addition to these fasteners. For example, in some embodiments, the first end of fastener 110d is threaded through the plurality of loops and the end 160 is attached to the substantially flat sheet. The second end may be releasably attached to the substantially flat sheet so that when the user is ready to transform the substantially flat sheet into the receptacle, the user simply threads the second end 170 of the fastener 110d through the loop 165 and then pulls the second end with respect to the loop to cause the perimeter edge of the substantially flat sheet to be drawn radially inward thereby forming the receptacle having a mouth opening defined by the perimeter edge of the substantially flat sheet.

### Method of Manufacture of a Receptacle

In various embodiments, the receptacle described may be manufactured using various techniques depending on the materials used. In some embodiments, the receptacle may be manufactured by first cutting a material into a particular shape. The material may be a polymer, a plastic blend, a woven material or any other suitable material as described above. In some embodiments, the material may be cut into a circular shaped substantially flat sheet having a perimeter and an edge. Next one or more fasteners are attached adjacent the perimeter of the substantially flat sheet so that a first fastener is moveable with respect to a second fastener and when the first fastener is moved with respect to the second fastener, the substantially flat sheet is transformed into a container having an opening defined by the perimeter edge of the sheet.

In various embodiments, the plurality of fasteners may be attached to the substantially flat sheet by first positioning the first and the second fasteners adjacent to the perimeter of the substantially flat sheet. Once the first and second fasteners are positioned, the edges of the substantially flat sheet are folded over to form one or more loops about the perimeter edge of the substantially flat sheet and the edge is attached to a portion of the substantially flat sheet radially inward of the perimeter. In various embodiments where the substantially flat sheet is formed from a polymer of plastic blend, the edge can be attached to form the one or more loops using friction stir welding, adhesive or any other suitable attachment mechanism.

In other embodiments, the step of attaching the plurality of fasteners adjacent the perimeter of the substantially flat sheet may be accomplished by attaching a plurality of loops adjacent the perimeter of the substantially flat sheet. In these embodiments, the one or more loops are formed separate from the substantially flat sheet and are then attached using any suitable method such as an adhesive, friction stir welding or sewing the loops to the substantially flat sheet. It should be understood that the loops may be coupled to the substantially flat sheet using any suitable method. Once the loops are attached, the first and second fasteners may be threaded through the one or more loops so that the first and second fasteners may be moved with respect to one another. In various embodiments, the first fastener is a first string and the second fastener is a second string.

### Conclusion

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, while several embodiments above include using a substantially flat circular shaped sheet, other embodiments may use an oval shaped sheet, a square shaped sheet or a rectangular shaped sheet. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A receptacle comprising:
a. a substantially flat sheet comprising a perimeter;
b. a plurality of loops positioned adjacent the perimeter of the substantially flat sheet;
c. at least two strings, each of the at least two strings comprising:
i. a first end; and
ii. a second end,
wherein
a first string is threaded through the plurality of loops and the first string first end is coupled to the first string second end;
a second string is threaded through the plurality of loops and the second string first end is coupled to the second string second end;
the first string can be pulled relative to the second string.

2. The receptacle of claim 1, wherein the substantially flat sheet:
a. is substantially circular in shape; and
b. is formed from a material selected from a group consisting of:
i. a plastic;
ii. a polymer;
iii. a biodegradable material;
iv. cloth; and
v. paper.

3. The receptacle of claim 1, further comprising a third string coupled to the substantially flat sheet intermediate a center point of the substantially flat sheet and the first and second strings, wherein the third string is moveable with respect to the substantially flat sheet.

4. The receptacle of claim 3, wherein the third string is woven into the flat sheet and at least one portion of the third string is separated from the substantially flat sheet to allow a user to pull the third string relative to the substantially flat sheet.

5. The receptacle of claim 1, further comprising:
a. a first elongated loop positioned adjacent the perimeter of the substantially flat sheet, wherein the first elongated loop comprises:
i. a first end, and
ii. a second end,
b. a second elongated loop positioned adjacent the perimeter of the substantially flat sheet, wherein the second elongated loop comprises:
i. a first end, and
ii. a second end,
c. a first gap positioned intermediate the first elongated loop first end and the second elongated loop second end; and
d. a second gap positioned intermediate the first elongated loop second end and the second elongated loop first end,
wherein
a first portion of the first string and a first portion of the second string are accessible at the first gap, and
a second portion of the first string and a second portion of the second string are accessible at the second gap.

6. The receptacle of claim 5, wherein:
a. the first string is of a first color; and
b. the second string is of a second color.

7. The receptacle of claim 1, wherein when the first string is pulled relative to the second string, the substantially flat sheet transforms into a sack with an opening defined by the perimeter of the substantially flat sheet.

8. The receptacle of claim 1, further comprising a plurality of ribs extending linearly from across the substantially flat sheet from a first point on the perimeter to a second point on the perimeter.

9. The receptacle of claim 8, wherein each of the plurality of ribs pass through a center point of the substantially flat sheet.

10. The receptacle of claim 8, wherein each of the plurality of ribs are formed integral with the substantially flat sheet.

11. The receptacle of claim 1, further comprising a plurality of stakes for releasably securing the perimeter of the substantially flat sheet to a ground surface.

12. The receptacle of claim 11, wherein each one of the plurality of stakes comprises a first portion that is inserted into the ground and a second portion that is configured to press against a portion of the perimeter of the substantially flat sheet.

13. The receptacle of claim 1, wherein the plurality of loops are selected from a group consisting of:
a. a plurality of cutouts formed about the perimeter of the substantially flat sheet;
b. a plurality of loops formed by hemming the edge of the substantially flat sheet adjacent the perimeter;
c. a plurality of loops formed by coupling the loops to the substantially flat sheet adjacent the perimeter; and
d. a plurality of loops formed from the same material as the substantially flat sheet.

14. The receptacle of claim 1, further comprising one or more stakes for securing one of the plurality of fasteners to the ground so that another one of the one or more fasteners can be pulled with respect to the one of the one or more fasteners.

15. A receptacle comprising:
a. a substantially flat sheet comprising a perimeter;
b. a plurality of loops positioned adjacent the perimeter of the substantially flat sheet;
c. at least two strings comprising:
i. a first end; and
ii. a second end,
wherein
a first string and a second string are retained in place by the plurality of loops;
the sheet is moveable between a first position in which sheet is substantially flat, and
a second position in which the sheet forms a container having an open mouth when the first string is pulled with respect to the second string in an radially outward direction.

16. A method of manufacturing a receptacle comprising the steps of:
a. forming a substantially flat sheet comprising a perimeter; and
b. attaching a plurality of fasteners adjacent the perimeter of the substantially flat sheet,
wherein
a first fastener is moveable with respect to a second fastener;
when the first fastener is moved with respect to the second fastener, the substantially flat sheet is transformed into a container having an opening defined by the perimeter.

17. The method of manufacturing a receptacle of claim 16, wherein the step of attaching the plurality of fasteners adjacent the perimeter of the substantially flat sheet further comprises:
a. positioning the first and the second fasteners adjacent to the perimeter of the substantially flat sheet;
b. folding over the edge of the substantially flat sheet to form one or more loops about the perimeter of the substantially flat sheet; and
c. attaching the edge of the substantially flat sheet to a portion of the substantially flat sheet radially inward of the perimeter.

18. The method of manufacturing a receptacle of claim 17, wherein attaching the edge of the substantially flat sheet further comprises friction welding the edge to the portion of the substantially sheet.

19. The method of manufacturing a receptacle of claim 17, wherein the step of attaching the plurality of fasteners adjacent the perimeter of the substantially flat sheet further comprises:
a. coupling a plurality of loops adjacent the perimeter of the substantially flat sheet; and
b. threading the first and the second fastener through the plurality of loops.

20. The method of manufacturing a receptacle of claim 19, wherein
a. the first fastener is a first string; and
b. the second fastener is a second string.
